(19) United States
(12) Patent Application Publication
(10) Pub. No.: US 2007/0215677 A1
(43) Pub. Date: Sep. 20, 2007

(54) Cold gas-dynamic spraying method for joining ceramic and metallic articles

(75) Inventors: Margaret M. Floyd, Chandler, AZ (US); Derek Raybould, Denville, NJ (US); Daniel C. Troller, Fountain Hills, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/376,669

(22) Filed: Mar. 14, 2006

(51) Int. Cl. B23K 31/02

(52) U.S. Cl. 228/122.1

(57) ABSTRACT

A method for joining a first component surface to a ceramic component surface includes cold gas-dynamic spraying a first metal powder onto the ceramic component surface to form a first metal coating. The first component surface is then bonded to the metal coating on the ceramic component surface. The bonding step may be a thermal process such as a brazing process. A mechanical bond may also be formed by an interference fitting such as press or shrink fitting.

### TECHNICAL FIELD

The present invention relates to methods for joining ceramic and metal articles together and, more particularly, to methods for applying braze compositions onto ceramic articles such as ceramic turbocharger components as part of a brazing method.

### BACKGROUND

Brazing is a joining process by which a filler metal is heated until it melts and is distributed between two or more close-fitting components. At its liquid temperature, the molten filler metal interacts with a thin layer of the base metals from each of the components. The heated region is then cooled to produce an exceptionally strong joint due to grain structure interaction. The brazed ceramic to metal joint is commonly a sandwich of different, metallurgically linked layers, with at least one transition layer between the base metals.

Although brazing effectively joins components in many applications, the process has some limitations. For instance, some brazements may not be as strong as the materials they join because the metals partially dissolve each other at their interface, and the re-solidified joint alloy grain structures may be somewhat uncontrolled. A brazement may be annealed or cooled at a proscribed rate to control the joint's grain structure and alloying, and to thereby strengthen the brazed joint. For example, slow cooling may reduce potentially detrimental effects resulting from differences in thermal expansion between a metal and a ceramic.

Also, some materials are not easily or effectively joined using a brazing process. For example, there is currently no effective and efficient process for creating a high temperature mechanical bond between ceramic and metallic articles. Conventional furnace brazing, which is typically used to braze weld two metal substrates, is not a sufficiently hot process to melt many ceramic materials and allow the ceramic and metal to react or bond mechanically. Alternatively, brazing at relatively high temperatures will bond a metal and a ceramic, but the thermal expansion mismatch between the two materials may stress and weaken the bond, or even cause the ceramic to crack as the joint cools from the brazing temperature. Stress related to a thermal expansion mismatch may be at least partially reduced by creating a transition zone that reduces the stress from the thermal expansion mismatch between the metal and the ceramic. The transition zone in the brazed joint may require multiple layers, however, and consequently may be expensive and only useful for joining a somewhat limited set of components.

Alternative methods for joining ceramics may also be problematic. For example, pressing or shrink fitting, i.e. by inserting ceramic wear parts into a metal holder, may be an attractive low-cost joining method. However, ceramics typically have no ductility and often have a low toughness. Thus, joining a ceramic component to another component by a press or shrink fit is difficult and prone to failure on the part of the ceramic due to tension stress.

Hence, there is a need for a method for joining metal and ceramic articles in a manner that creates a strong and durable bond. There is a further need for a joining method that prevents stress due to a thermal expansion mismatch between the joined ceramic and metal materials. There is also a need for a method that is sufficiently versatile to be useful for a wide variety of components including parts having complex geometries.

### BRIEF SUMMARY

The present invention provides a method for joining a first component surface to a ceramic component surface. A first metal powder is cold gas-dynamic sprayed onto the ceramic component surface to form a first metal coating. The first component surface is then bonded to the metal coating on the ceramic component surface. The bonding step may be a thermal process such as a brazing process. A mechanical bond may also be formed by an interference fitting such as press or shrink fitting.

Other independent features and advantages of the preferred methods will become apparent from the following detailed description, taken in conjunction with the accompanying drawing which illustrates, by way of example, the principles of the invention.

### BRIEF DESCRIPTION OF THE DRAWING

FIG. 1 is a schematic view of a cold spraying apparatus;

FIG. 2 is a top cutaway view of a turbocharger wheel and an associated shaft, the turbocharger wheel having a central bore coated with a cold sprayed metal layer;

FIG. 3 is a block diagram depicting an exemplary method for joining a ceramic and a metal component; and

FIG. 4 is a block diagram depicting another exemplary method for joining a ceramic and a metal component.

FIG. 5 is a 200× magnification image depicting the microstructure of a cold sprayed AlSi coating on a silicon nitride substrate.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The various embodiments of the present invention provide methods for durably joining metal and ceramic articles despite any thermal expansion mismatches between the joined materials. The methods are performed using a cold gas-dynamic spraying (hereinafter “cold spraying”) process that is useful for joining a wide variety of components.

Cold spraying is a technique that uses a pressurized carrier gas to accelerate particles through a supersonic nozzle and toward a targeted surface. The cold spraying process is referred to as a cold process because the particles are mixed and sprayed at a temperature that is well below their melting point, and the particles are near ambient temperature when they impact with the targeted surface. Converted kinetic energy, rather than a high particle temperature, causes the particles to plastically deform, which in turn causes the particles to form a bond with the targeted surface. Bonding to the component surface occurs as a solid state process with insufficient thermal energy to transition the solid powders to molten droplets. Cold spraying techniques can therefore produce a thermal or wear-resistant coating that strengthens and protects the component using a variety of materials that may not be easily applied using techniques that expose the materials and coatings to high temperatures.

A variety of different systems and implementations can be used to perform a cold spraying process. For example, U.S. Pat. No 5,302,414, entitled “Gas-Dynamic Spraying Method for Applying a Coating” describes an apparatus designed to accelerate to supersonic speed materials having a particle size of between 5 to about 50 microns. The particles are sprayed from a nozzle at a velocity ranging between 300 and 1200 m/s. Heat is applied to the carrier gas to between about 300 and about 400° C., but expansion in the nozzle causes the spraying material to cool. The spraying material therefore returns to near ambient temperature by the time it reaches the targeted substrate surface.

When the sprayed particles impinge on the targeted substrate surface, the impact breaks up any oxide films on the particle and substrate surfaces as the particles bond to the substrate. Thus, cold spraying techniques prevent unwanted oxidation of the substrate or powder, and thereby produce a cleaner coating than many other processes. Such techniques also enable the formation of non-equilibrium coatings. More specifically, since the sprayed materials are not heated or otherwise caused to react with each other or with the substrate, coatings can be produced that are not producible using other techniques.

In contrast to cold spraying, thermal spraying processes include heating methods to bring at least some of the spray material to a melting point prior to impacting the sprayed surface, thereby producing a strong and uniform coating. Some thermal spraying processes also utilize plasma to ionize the sprayed materials or to assist in changing the sprayed materials from solid phase to liquid or gas phase. Melted spraying particles produce liquid splats that land on a targeted substrate surface and bond thereto. Some thermal spraying techniques only supply sufficient heat to melt a fraction of the spraying material particles, and consequently only cause surface melting to occur.

Cold spraying is sometimes a preferred spraying method for various substrates because it enables the sprayed materials to bond with such substrates at a relatively low temperature. The coating materials that are sprayed using the cold gas-dynamic spraying process typically only incur a net gain of about 100° C. with respect to the ambient temperature. Plastic deformation facilitates bonding of sprayed particles to the substrate. Further, since the sprayed particles are kept well below their melting temperatures, they are not very susceptible to oxidation or other reactions.

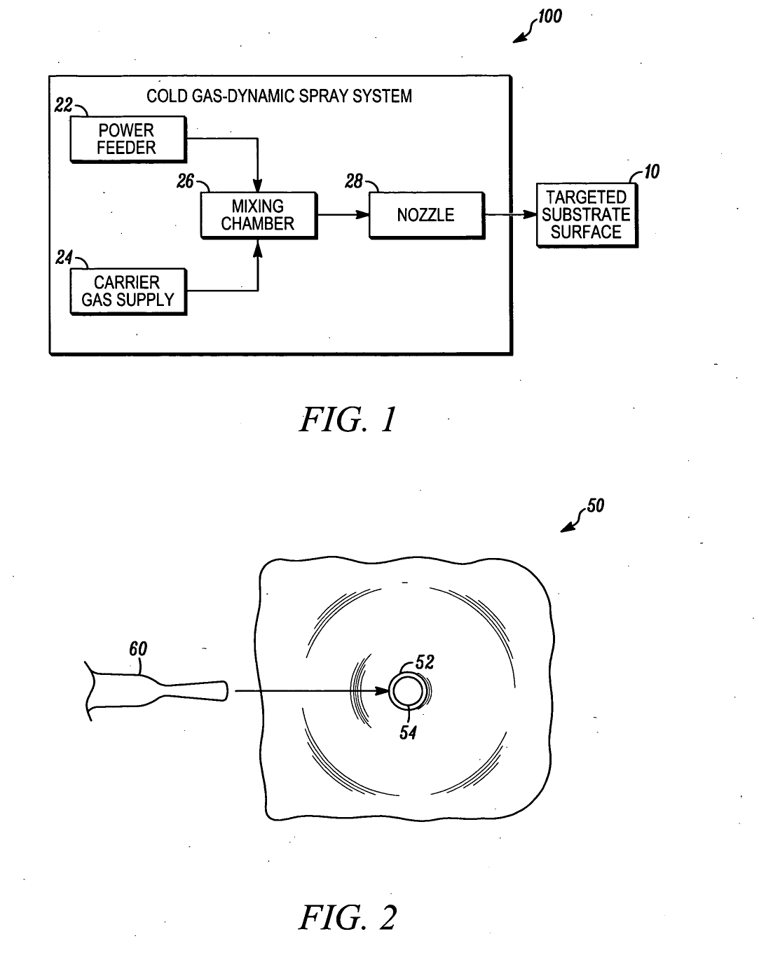

Turning now to FIG. 1, an exemplary cold spraying system 100 is illustrated diagrammatically. The system 100 is illustrated as a general scheme, and additional features and components can be implemented into the system 100 as necessary. The main components of the cold spraying system 100 include a powder feeder 22 for providing powder materials, a carrier gas supply 24, a mixing chamber 26 and a convergent-divergent nozzle 28.

In general, the system 100 transports the metal powder mixtures with a suitable pressurized gas to the mixing chamber 26. The particles are accelerated by the pressurized carrier gas through the specially designed supersonic nozzle 28. Exemplary carrier gases include air, helium and nitrogen. When the powder particles are accelerated toward the nozzle 28, the carrier gas is typically heated to about 300 to 400° C. The nozzle 28 directs the accelerated powder particles toward a targeted surface 10 to form a dense and uniform coating. Due to expansion in the nozzle, the powder particles are close to ambient temperature when they impact with the targeted surface 10. If the particles reach a critical velocity, which is specific to each type of powder, the impact will cause any oxide films on the particles and/or on the targeted surface 10 to break up. Further, the kinetic energy associated with the impact causes plastic deformation of the particles, and further causes the particles to bond to the targeted surface 10.

Because the cold spraying system 100 is useful for depositing strong and durable coatings at temperatures far below the sprayed material melting point, cold spraying is a uniquely capable process for forming mechanically bonded metal coatings on ceramic components, i.e. as a braze composition or a soft press fitting material, and thereby enabling the ceramic component to subsequently be mechanically bonded to a metal component. Turning to FIG. 2, a ceramic turbocharger wheel 50 and a metal shaft 60 are depicted as an exemplary pair of components that are joinable by way of a cold sprayed metal coating 54, although it is understood that this is just one of numerous examples of exemplary components that may be joinable according to the principles of the present invention. The coating 54 is a metal layer formed from by cold spraying a metal powder onto a ceramic surface of a wheel bore 52 that is adapted to receive and be joined to the shaft 60. When cold spraying the metal powder onto the ceramic wheel bore surface, the kinetic energy associated with the impact causes the metal powder to adhere and/or mechanically bond to the wheel bore 52 as a brazement. Thereafter, the coated wheel bore 52 may be joined to the metal shaft by inserting the shaft 60 into the wheel bore 52 and furnace heating the two components. The brazement reacts with the shaft metal at a temperature that is sufficiently low to minimize thermal stresses that would be caused by high temperature brazing.

The cold spray coating 54 may also be a plurality of cold sprayed layers, with one or more outer layers having a different composition than the layer formed directly on the wheel bore 52 or other ceramic substrate. According to one embodiment, all the layers are metal coatings, but only the outermost layer functions as a brazement that reacts with the shaft 60 or other metal substrate. An alternate embodiment includes at least one outer cold sprayed layer that has a lower melting point than that of the cold sprayed layer formed directly on the ceramic substrate. The at least one outer cold sprayed metal layer may be melted, before or during the brazing process, and react with the layer formed directly on the ceramic substrate to form a strong alloy having a higher melting point than the at least one outer layer had prior to alloying.

Alternatively, a cold sprayed ceramic component may be press fitted into a metal component, or vice versa, with the stresses associated with press fitting being primarily taken by the ductile cold sprayed metal. Returning to FIG. 2, if the metal shaft 60 is press fitted into the wheel bore 52 then the cold sprayed metal coating 54 is subjected to deformation or other related stresses instead of the ceramic wheel bore 52. The cold sprayed coating 54 deforms and mechanically secures the metal and ceramic components together, while protecting the ceramic from breaking during the press fitting process.

The metal used for the cold spray coating 54 will depend on the ceramic substrate, and the utilities for both the substrate and the coating. Soft metals such as aluminum and copper are capable of undergoing substantial deformation during a press or shrink fitting process, but would have limited utility in high temperature environments. Iron is relatively soft and would have greater utility at high temperatures. Stainless steels would be even harder, and have greater high temperature and strength capabilities, as would many other alloys.

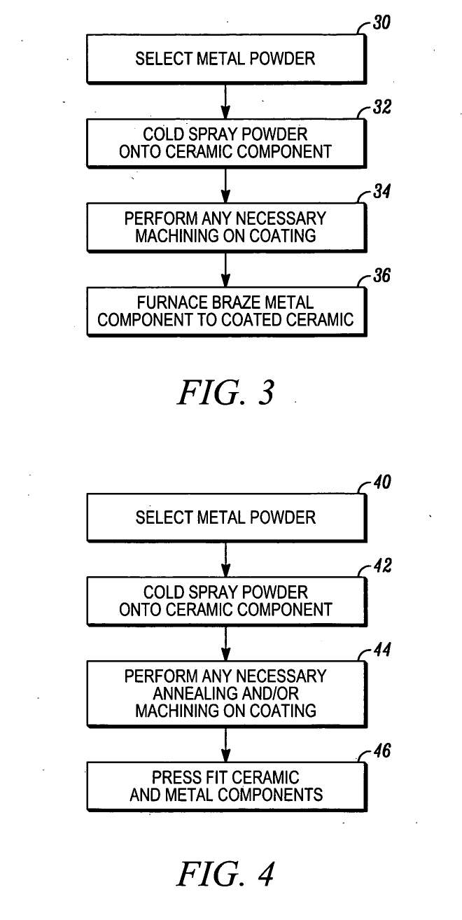

Turning now to FIG. 3, a block diagram depicts an exemplary method for joining ceramic and metal components. Starting with step 30, one or more metals are selected for spraying on a ceramic substrate. As previously discussed, the one or more metals are selected for spraying depending on the characteristics of the ceramic substrate, the intended use for the joined components, and the type of joining method to be employed. For a braze joint, some exemplary metals may include aluminum alloys, and perhaps more particularly aluminum silicon alloys having melting points well below 600° C. Other exemplary metals include copper alloys having braze temperatures of 650 to 1000° C. Such copper alloys may be admixed or prealloyed with Ti, and/or Ag. Also, titanium alloys may be cold sprayed, but such alloys are often somewhat expensive and have higher melting points of 750 to 1000° C., but also have comparatively higher strengths. Other suitable brazement coatings are silver and gold alloys, having melting points of ˜850° C. and ˜1050° C., respectively. However, such alloys may be even more expensive. Nickel-based coatings also have brazing potential, but have very high braze temperatures of about 1000 to 1200° C. The substrate may be a surface of any type of ceramic component.

As previously mentioned, the cold spray coating method benefits ceramic components because the sprayed metals adhere and/or mechanically bond to the component surface. The spraying is performed well below the melting temperature of the sprayed metal, so any potential thermal expansion mismatch between the sprayed metal and the ceramic material may be avoided. The cold sprayed coating enables subsequent brazing to be carried out at sufficiently low temperature to minimize the stress from a thermal expansion mismatch. Alternatively, multiple layers may be cold sprayed onto the ceramic followed by performance of just one conventional braze operation. This approach avoids the need for repeated braze operations to build up the layered structure, and the associated cost of repeated “entries” into a vacuum chamber to perform the braze operations.

Exemplary ceramic components that may benefit from cold sprayed metal coatings include components included in aerospace and other high technology applications, although there are countless other applications for which the present invention may be beneficial. Some exemplary ceramic materials, to name a few, include alumina, alumina nitride, boron nitride, silicon nitride, silicon carbide, yittrium aluminum garnet (YAG).

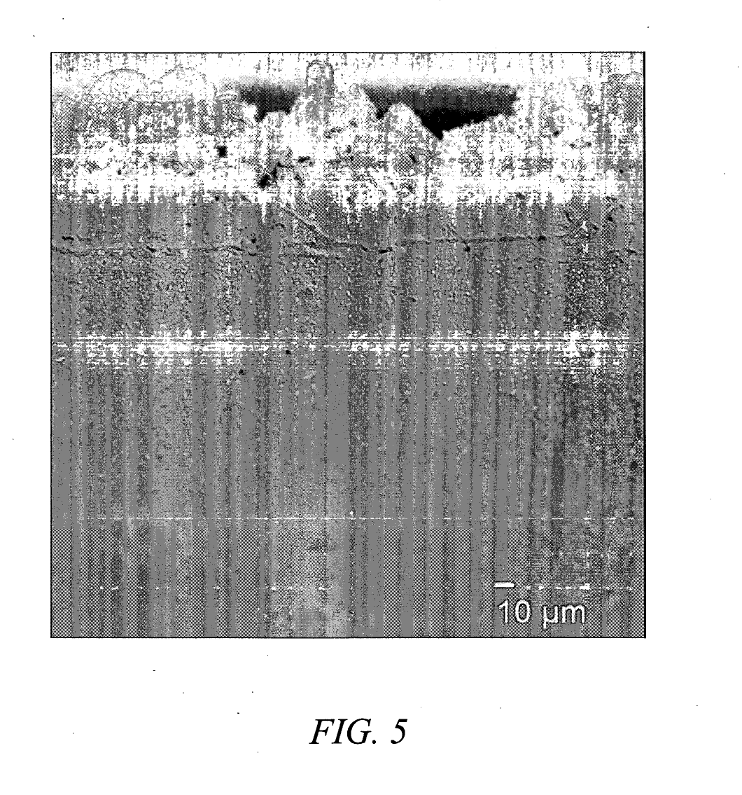

After selecting an appropriate spraying material, the system 100 from FIG. 1 transports the powder of one or more metals with a suitable pressurized gas to the mixing chamber 26, and the powder particles are accelerated by the pressurized carrier gas through the nozzle 28 toward a targeted surface 10 as step 32. The metal particles bond with the targeted ceramic surface and form a dense coating having a substantially uniform microstructure and composition. FIG. 5 is a 200× magnification image depicting the microstructure of an aluminum silicon (AlSi) metal coating cold sprayed onto a silicon nitride substrate. Cold spraying was performed using nitrogen as a carrier gas and a relatively low cold spray velocity. The AlSi may subsequently be used as a brazement. According to other embodiments, Si powder or Al-high Si powder may be cold sprayed as part of the metal coating to further reduce the melting point of the AlSi. Bonding to a metal such as nickel or a nickel-based superalloy during the braze operation results in formation of a nickel aluminide alloy, which is a strong, high melting point material. There are numerous other substrate metals that may be alloyed with the aluminum alloy or other cold spray coating.

The cold sprayed coating may need to be smoothed, or its thickness may need to be modified before joining the coated ceramic substrate to a metal component. Smoothing, thinning, or any other coating machining is performed as step 34 to prepare the coating for a brazing process. Machining is readily performable on the cold spray coating without damage to its bond to the ceramic. Precision joints may consequently be formed, increasing the success rate for the subsequent braze operation and also increasing the braze quality.

The ceramic and metal components are next placed into a furnace for brazing as step 36. The furnace is preferably a vacuum furnace, but may possibly be a furnace in which brazing is performed in a controlled protective atmosphere. During the furnace brazing process, the cold sprayed metal coating remains adhered and/or mechanically bonded to the ceramic component while reacting with the metal component. As previously mentioned, the furnace brazing is performed at a temperature that is sufficiently low to minimize thermal stresses that would be caused by high temperature brazing.

Of course, brazing temperatures will vary depending in part on the different types of braze alloys that may be used. Using Al—Si as an exemplary braze alloy, which has a eutectic temperature of 577° C., cold spraying over a layer of Fe previously cold sprayed on a substrate and then heating at or below the alloy braze temperature for sufficient time to allow diffusion of Al into the Fe will cause the formation of Al₃Fe intermetallic having a 1160° C. melt temperature. At a minimum concentration of Al of 10 wt % the melt temperature is +900° C. A similar effect results from using Al—Si as a braze alloy onto a layer of Ti previously cold sprayed on a substrate. Al diffuses into the Ti so that the minimum concentration of 5 wt % Ti in the Al gives a +1,000° C. melt temperature. Such control of the final joint chemistry is facilitated by the ability of cold spray to put down a thin layer that can be readily machined or rough polished so that a precise thickness of braze material may be used. Although there are innumerable other applications, these examples illustrate how cold spray may reduce the braze temperature by a factor of around 2 without loss of strength or temperature capability. Further, the brazing process produces a highly durable bond between the ceramic and the metal components while avoiding conventional problems associated with thermal expansion mismatches.

FIG. 4 is a block diagram that depicts another joining method, including a press or shrink fitting step in place of brazing. For both of these approaches, the ready machinability of the cold sprayed coating to a precise dimension is beneficial. Press fitting involves the use of force to obtain a joint by pressing one part into another. A ceramic's low toughness and tensile strength makes it prone to failure, especially at any irregularities in the surface. The cold sprayed metal layer can readily deform so that high stresses due to surface irregularities may be avoided. Further, stress due to any dimensional mismatch can be carefully controlled to impart desired joint strength without breaking the ceramic. Shrink fits are similar to press fits in that one component is larger than a corresponding receiving hole. During a shrink fit procedure, the part having the receiving hole is heated until the thermal expansion is sufficient for the second part to be easily received in the hole. Subsequent cooling produces stresses in each part similar to those resulting from a press fit procedure. Again, the ability of the cold spray metal to be readily machined to precise tolerances is beneficial in relieving stresses that would otherwise affect the interference fit. Starting with step 40, one or more metals are selected for spraying on a ceramic substrate. As in the previous method, the one or more metals are selected for spraying depending on the characteristics of the ceramic substrate, and its intended use. The substrate may be a surface of any type of ceramic component. For this and the prior method, it may be necessary or advantageous to perform grit blasting or other surface processing on the ceramic component prior to cold spraying in order to provide a well-bonded coating. A powder of the selected one or more metals is then cold sprayed onto the ceramic substrate as step 42. The metal particles bond with the targeted ceramic surface and form a dense coating having a substantially uniform microstructure and composition. Then, any smoothing, thinning, or other machining is performed as step 44 to prepare the coating for a joining process.

Further, prior to press or shrink fitting, the cold sprayed coating may be annealed to reduce the residual stress from the cold spray coating process and to remove the work hardening that may be a the product of cold spraying. The resulting softer coating is more amenable to deformation during the press or shrink fitting. The degree of annealing out of the cold work will depend on the degree of deformation and cold work that is required from the press or shrink fitting process to produce a strong bond without overstressing the ceramic.

Instead of brazing the ceramic and metal components as in the previous method, the components are press or shrink fitted as step 46 to form a mechanical bond between the two. The cold sprayed metal coating functions as an interfacial layer between the joined components, with the stresses associated with press fitting being primarily taken by the ductile cold sprayed metal. The cold sprayed coating mechanically bonds with the metal component and secures the metal and ceramic components together, while protecting the ceramic from breaking during the press fitting process.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for joining a first component surface to a ceramic component surface, the method comprising:
cold gas-dynamic spraying a first metal powder onto the ceramic component surface to form a first metal coating; and
bonding the first component surface to the first metal coating on the ceramic component surface.

2. The method according to claim 1, wherein the bonding step is a brazing process.

3. The method according to claim 2, wherein the first metal coating is a brazement that reacts with the first component surface during the brazing process.

4. The method according to claim 2, wherein the brazing process comprises adding a brazement to the first metal coating, the brazement having a lower melting temperature than the first metal coating, and being sufficiently reactive with the first metal coating to form an alloy with the first metal coating during the brazing process, the alloy having a lower melting temperature than the first metal coating.

5. The method according to claim 2, wherein the furnace brazing process causes the brazing metal layer to react with the metal component surface while maintaining the mechanical bond between the ceramic component surface and the brazing metal layer.

6. The method according to claim 1, wherein the cold gas-dynamic spraying produces a mechanical bond between the ceramic component surface and the first metal coating.

7. The method according to claim 1, wherein the second component surface is a metal material.

8. The method according to claim 1, further comprising:
cold spraying at least one additional metal powder onto the component surface prior to forming the first metal coating to form at least one additional metal coating, the first metal coating being an outermost coating.

9. The method according to claim 8, wherein the bonding step is a brazing process, and the outermost coating is a brazement that reacts with the first component surface.

10. The method according to claim 1, further comprising the step of machining the first metal coating prior to bonding the metal component surface and the first metal coating.

11. The method according to claim 1, wherein the ceramic and first components are aerospace components.

12. A method for joining a first component surface with a ceramic component surface, the method comprising:
cold gas-dynamic spraying a metal powder onto the ceramic component surface to form a metal layer; and
mechanically bonding the first component surface with the metal layer on the ceramic component surface.

13. The method according to claim 12, wherein the mechanically bonding step comprises interference fitting the first component surface with the metal layer.

14. The method according to claim 12, wherein the mechanically bonding step comprises shrink fitting the first component surface with the metal layer.

15. The method according to claim 12, wherein the first component surface is a ceramic material.

16. The method according to claim 12, wherein the first component surface is a metal material.

17. The method according to claim 12, wherein the cold gas-dynamic spraying produces a mechanical bond between the ceramic component surface and the metal layer.

18. The method according to claim 17, wherein the press mechanically bonding step produces a mechanical bond between the first component surface and the metal layer while maintaining the mechanical bond between the ceramic component surface and the metal layer.

19. The method according to claim 12, further comprising the step of machining the metal layer prior to mechanically bonding the metal component surface with the metal layer.

20. The method according to claim 12, wherein the first and metal components are aerospace components.
